(19) United States
(12) Patent Application Publication
(10) Pub. No.: US 2024/0110599 A1
(43) Pub. Date: Apr. 4, 2024

(54) SENSOR BEARING UNIT AND ASSOCIATED APPARATUS

(71) Applicant: AKTIEBOLAGET SKF, GOTEBORG (SE)

(72) Inventor: Maruti Vitthal Khaire, Pune (IN)

(21) Appl. No.: 18/460,783

(22) Filed: Sep. 5, 2023

(30) Foreign Application Priority Data
Sep. 30, 2022 (IN) 202241056455

(51) Int. Cl. F16C 41/00; G01D 5/20

(52) U.S. Cl. CPC F16C 41/007; G01D 5/204; F16C 2233/00

(57) ABSTRACT

A sensor bearing unit includes a bearing having a first ring and a second ring centered on an axis, an impulse ring secured to the first ring of the bearing, and a sensor device configured to detect rotational parameters of the impulse ring. The sensor device includes a sensor housing secured to the second ring of the bearing and at least one inductive sensor comprising a reference coil and a sense coil supported by the sensor housing and configured to cooperate with the impulse ring. A length of a circumferential spacing between the reference coil and the sense coil is greater than or equal to a circumferential length of the reference coil and greater than or equal to a circumferential length of the sense coil.

### CROSS-REFERENCE

This application claims priority to Indian patent application no. 202241056455 filed on Sep. 30, 2022, the contents of which are fully incorporated herein by reference.

### TECHNOLOGICAL FIELD

The present disclosure is directed to a sensor bearing unit comprising a bearing, an impulse ring and a sensor device.

### BACKGROUND

Today, sensor bearing units are commonly used in a wide range of technical fields, for example in the automotive industry and the aerospace industry. These units provide high quality signals and transmissions, while allowing integration in simpler and more compact apparatus.

A sensor bearing unit generally comprises a bearing, an impulse ring secured to the rotatable ring of the bearing, and a sensor device for sensing the angular position of the impulse ring with respect to the fixed ring of the bearing.

The sensor device is provided with at least one sensor element facing the impulse ring in order to determine the angular position, speed and direction of the rotatable ring. The sensor device is also provided with a sensor housing supporting the sensor element and secured to the fixed ring of the bearing.

A sensor bearing unit may be used for example in a motor, such as a permanent magnet synchronous motor or a brushless motor, for providing information regarding the position of the motor's rotor with respect to the motor's stator windings. The positional information allows for proper commutation and control of the stator windings.

The sensor element of the sensor device may use induction technology. In this case, the inductive sensor comprises a sensing coil and a reference coil. The output of the inductive sensor switches low when the sense inductance drops below the reference inductance and returns high when the reference inductance is higher than the sense inductance.

Conventionally, the sensing and reference coils of an inductive sensor are arranged side by side. The sense and reference coils differential inductance determines the signal switch as well as the duration of the high and low signals. However, side by side sense and reference coils are typically arranged with a minimum possible gap between the coils and thus it is difficult to achieve high and low signals having an equal width which can be useful to improve the operation of an electric motor.

### SUMMARY

One aspect of the present disclosure is to overcome this drawback.

The disclosure relates to a sensor bearing unit that includes a bearing and a sensor device. The bearing comprises a first ring and a second ring centered on an axis with an impulse ring secured to the first ring of the bearing. The sensor device is for configured to detect rotational parameters of the impulse ring and comprises a sensor housing secured to the second ring of the bearing and at least one inductive sensor having a reference coil and a sense coil supported by the sensor housing and configured to cooperate with the impulse ring.

According to a general feature, the circumferential spacing between the reference coil and the sense coil of the inductive sensor is at least equal to the circumferential dimension of each coil.

With such a design, high and low signals with equal widths can be obtained based on a sense and reference inductance differential of the inductive sensor.

In one embodiment, the impulse ring is made of metal and provided with alternating teeth and spaces, and the inductive sensor of the sensor device is capable of sensing the metal impulse ring teeth and spaces.

Advantageously, the reference and sense coils of the inductive sensor are arranged relative to the teeth of the impulse ring so that for any given tooth that entirely faces a circumferential space between the reference and sense coils and does not overlap a first one of the coils, that tooth overlaps the other one of the coils with an overlap ratio of 50% to 75%.

Preferably, the sensor device further comprises a printed circuit board supporting the inductive sensor that is secured to the sensor housing. For example, the printed circuit board may be secured to an axial portion of the sensor housing. In one embodiment, the printed circuit board is made of multiple layers.

Advantageously, the reference and sense coils are stacked in multiple layers on the printed circuit board so that the equivalent inductance of each of these multi-layered coils is equal to the sum of the inductances of the coils that form each multi-layered coil.

Preferably, the sensor bearing unit comprises a plurality of inductive sensors spaced apart in the circumferential direction, each inductive sensor comprising a reference coil and a sense coil supported by the sensor housing and configured to cooperate with the impulse ring, the circumferential space between the reference and sense coils of each inductive sensor being at least equal to the circumferential dimension of each coil.

For example, the sensor bearing unit comprises a plurality of inductive sensors spaced apart in the circumferential direction, each inductive sensor comprising a reference coil and a sense coil supported by the sensor housing and cooperating with the impulse ring. The circumferential space between the reference and sense coils of each inductive sensor and the dimensioning of the impulse ring (i.e. the size and relative position of the teeth and spaces) is selected such that over the duty cycle the duration of the high signal is different than the duration of low signal.

For example, the first ring of the bearing is the inner ring and the second ring is the outer ring.

The disclosure is also directed to an apparatus comprising a rotating shaft and a sensor bearing unit as previously defined, wherein the first ring of the bearing is fixed on the rotating shaft.

### BRIEF DESCRIPTION OF THE DRAWINGS

The present disclosure and its advantages will be better understood by studying the detailed description of a specific embodiment given by way of a non-limiting example and illustrated by the appended drawings on which:

FIG. 1 is an axial sectional view of a sensor bearing unit according to an embodiment of the disclosure.

FIG. 2 is a front view of an impulse ring of the sensor bearing unit of FIG. 1.

FIG. 3 is a front view of a first embodiment of an inductive sensor and impulse ring for the sensor bearing unit of FIG. 1.

FIG. 4 is a front view of a second embodiment of an inductive sensor and impulse ring for the sensor bearing unit of FIG. 1.

FIG. 5 is a front view of a third embodiment of an inductive sensor and impulse ring for the sensor bearing unit of FIG. 1.

FIG. 6 is an axial sectional view of a sensor bearing unit according to alternate embodiment of the present disclosure which sensor bearing unit has a multi-layered circuit board and multi-layered coils.

### DETAILED DESCRIPTION

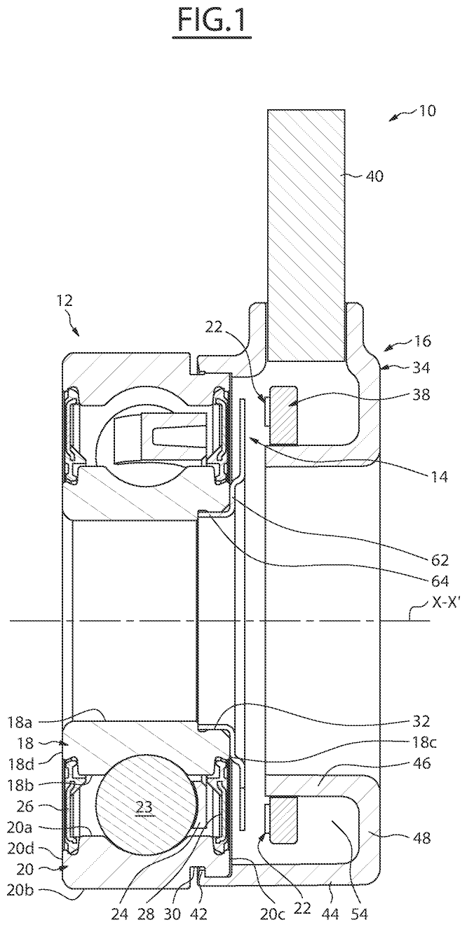

The sensor bearing unit 10 shown in FIG. 1 is configured to be used with an apparatus such as a motor, a brake system, a suspension system, or any rotating machine, in particular for an automotive vehicle or a two-wheeled vehicle.

Such an apparatus may be provided with a rotating shaft and a non-rotation casing. If the apparatus is an electric motor, a rotor is secured to the shaft and a stator is secured to the casing. The sensor bearing unit 10 may be mounted on the shaft and into the casing.

As shown on FIG. 1, the sensor bearing unit 10 comprises a bearing 12, and an impulse ring 14 and a sensor device 16 mounted on the bearing. The bearing 12 may be mounted on a shaft of an apparatus for tracking the rotation of the shaft.

The bearing 12 comprises a first ring 18 and a second ring 20. In the illustrated example, the first ring 18 is the inner ring and the second ring 20 is the outer ring. The inner and outer rings 18, 20 are concentric and have axes of rotation that extend axially along the bearing rotation axis X-X′ which runs in an axial direction. The outer ring 20 radially surrounds the inner ring 18. The inner and outer rings 18, 20 are made of steel.

As will be described hereinafter, the impulse ring 14 is secured to the inner ring 18, and the sensor device 16 is secured to the outer ring 20.

In the illustrated example, the bearing 12 also comprises a row of rolling elements 23, which are provided here in the form of balls, interposed between raceways (not referenced) formed on the inner and outer rings 18, 20.

The bearing 10 also comprises a cage 24 for maintaining a regular circumferential spacing of the rolling elements 23. The bearing 10 further comprises seals 26, 28 radially disposed between the inner and outer rings 18, 20 to define a closed space inside which the rolling elements 23 are arranged.

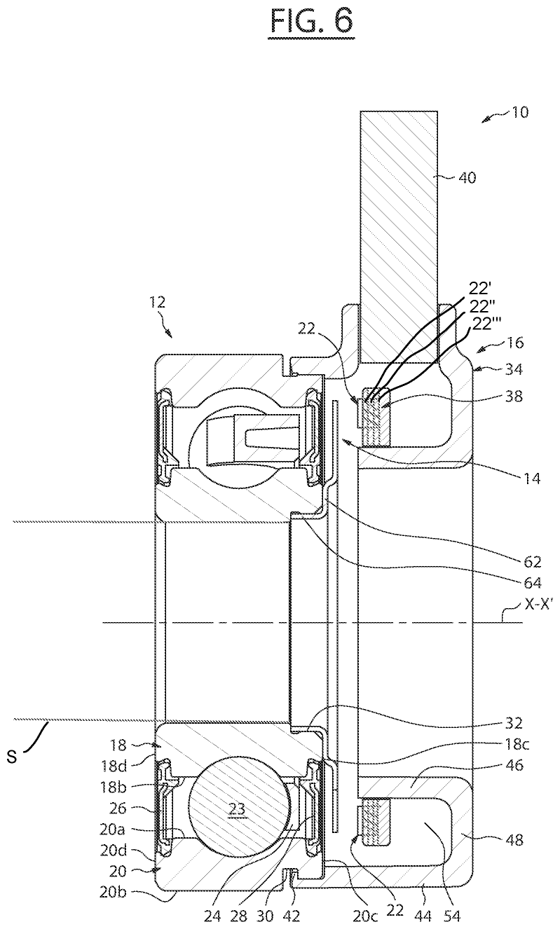

The inner ring 18 of the bearing may be mounted on the outer surface of a shaft S (FIG. 6) of an apparatus. The outer ring 20 may be mounted into a bore of a fixed casing of the apparatus.

The outer ring 20 is provided with a cylindrical inner surface or bore 20a and with an outer cylindrical surface 20b which is radially opposite to the bore 20a. In the illustrated example, a toroidal circular raceway for the rolling elements 23 is formed from the bore 20a, the raceway being directed radially inwards. The outer ring 20 is also provided with two opposite radial lateral faces 20c, 20d which axially delimit the bore 20a and the outer surface 20b of the ring.

A groove 30 is formed on the outer surface 20b of the outer ring. The groove 30 is oriented radially outwards. The groove 30 extends radially inwards from the outer surface 20b of the outer ring. In the illustrated example, the groove 30 has an annular form.

Similarly to the outer ring 20, the inner ring 18 is provided with a cylindrical inner surface or bore 18a and with an outer cylindrical surface 18b which is radially opposite to the bore 18a. In the illustrated example, a toroidal circular raceway for the rolling elements 23 is formed on the outer surface 18b, the raceway being directed radially outwards. The inner ring 18 is also provided with two opposite radial lateral faces 18c, 18d which axially delimit the bore 18a and the outer surface 18b of the ring.

The inner ring 18 further comprises a cylindrical groove 32 made in the bore 18a. The groove 32 is centered on the axis X-X′. The diameter of bore 18a is smaller than the diameter of the groove 32. The groove 32 opens on the lateral face 18c of the inner ring.

As previously mentioned, in the illustrated example the sensor device 16 is secured to the outer ring 20 of the bearing. The sensor device comprises a sensor body or housing 34 and inductive sensors 22 supported by the sensor housing 34.

The sensor device 16 also comprises a printed circuit board 38 secured to the sensor housing and supporting the inductive sensors 22. In the illustrated example, the sensor device 16 also comprises a connecting cable 40 for transmitting sensing data. Alternatively, the connecting cable may be omitted from the sensor device 16 if wireless sensor elements are used.

The sensor housing 34 has an annular form. In the illustrated example, the sensor housing 34 is secured to the groove 30 formed on the outer surface 20b of the outer ring. The sensor housing 34 is provided with an annular hook 42 that engages inside the groove 30 to axially retain the sensor housing 34 relative to the outer ring. The hook 42 extends radially inwards. In the illustrated example, the sensor housing 34 is provided with an annular hook 42. Alternatively, the sensor housing 34 may be provided with a plurality of hooks 42 spaced apart in the circumferential direction, preferably regularly. Alternatively, other fixing means could be used to secure the sensor housing to the outer ring 20 of the bearing.

The sensor housing 34 comprises an annular outer axial portion 44 provided with the annular hook 42, an annular inner axial portion 46 and an annular radial portion 48 extending between the outer and inner axial portions. The outer and inner axial portions 44, 48 are concentric and coaxial with the axis X-X′. The sensor housing 34 is concentric with the axis X-X′.

The outer axial portion 44 of the sensor housing radially surrounds the inner portion 46. The outer axial portion 44 extends axially from the radial portion 48 towards the bearing 12. The outer axial portion 44 extends axially from a large-diameter edge of the radial portion 48.

The outer axial portion 44 of the sensor housing extends axially closer to the bearing 12 than the inner axial portion 46. The inner axial portion 46 defines the bore of the sensor housing 34. The inner axial portion 46 extends axially from the radial portion 48 towards the bearing 12. The inner axial portion 46 extends axially from a small-diameter edge of the radial portion 48. The inner axial portion 46 remains axially spaced apart from the bearing 12 and from the impulse ring 14.

The sensor housing 34 defines an annular space 54 axially oriented towards the bearing 12. The space 54 is radially delimited by the outer and inner axial portions 44, 46. The space 54 is axially delimited by the radial portion 48.

As previously mentioned, the printed circuit board 38 is secured to the sensor housing 34. The printed circuit board 38 has an annular shape and is housed inside the space 54 defined by the sensor housing 34. The printed circuit board 38 is secured to the inner axial portion 46 of the sensor body. Alternatively, the printed circuit board 38 may be secured to the outer axial portion 44 of the sensor body.

The inductive sensors 22 are supported by the printed circuit board 38 which is itself supported by the sensor housing 34. As will be described below, the inductive sensors 22 are mounted on the axial side of the printed circuit board 38 that faces the impulse ring 14.

As previously mentioned, the impulse ring 14 is secured to the inner ring 18 of the bearing. In the illustrated example, the impulse ring 14 is secured to the bore 18a of the inner ring. The impulse ring 14 is secured in the groove 32 formed on the bore 18a. Alternatively, it could be possible to secure the impulse ring 14 onto the lateral 18c of the inner ring. In the disclosed example, the impulse ring 14 is made in one part. The impulse ring 14 is made of metal.

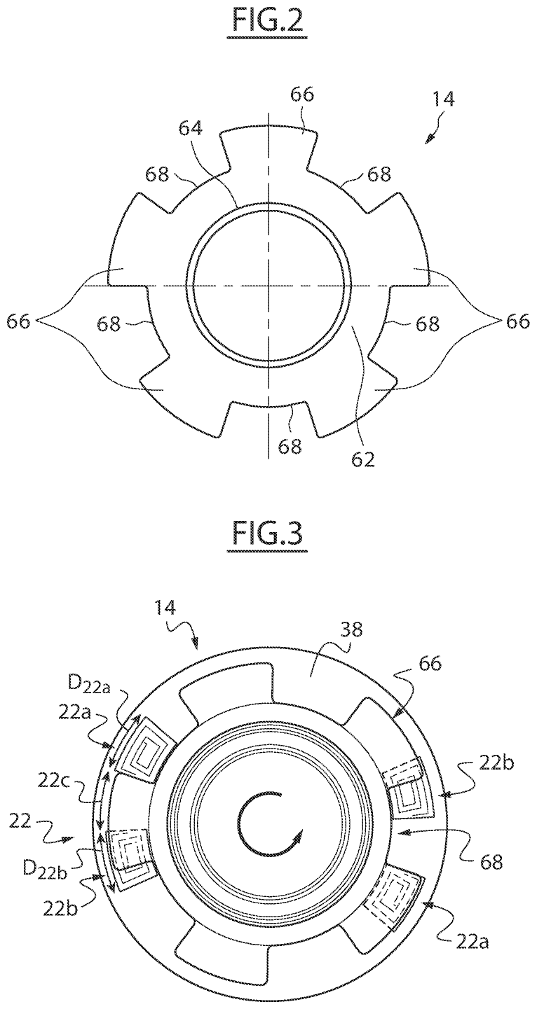

As shown in FIGS. 1 and 2, the impulse ring 14 comprises an annular radial portion 62, and a cylindrical inner axial portion 64 extending axially from the radial portion 62. The cylindrical portion 64 extends axially inward from the radial portion 62. The cylindrical portion 64 extends axially from a small-diameter edge of the radial portion 62. In the illustrated example, the radial portion 62 has a stepped shape.

The impulse ring 14 is axially mounted against the lateral face 18c of the inner ring. The radial portion 62 of the impulse ring axially abuts against the lateral face 18c. The cylindrical portion 64 is mounted into the groove 32 formed on the bore 18a. The cylindrical portion 64 is secured into the groove 32, for example by press-fitting.

The impulse ring 14 is also provided with a plurality of teeth 66 at its periphery. The teeth 66 are regularly spaced apart in the circumferential direction. A recess or space 68 exists between each pair of adjacent teeth 66. Hence, the impulse ring 14 is provided with alternating teeth 66 and spaces 68.

As previously mentioned, each inductive sensor 22 of the sensor device 16 is mounted on the axial side of the printed circuit board 38 that faces the impulse ring 14. Each inductive sensor 22 axially faces one of the teeth 66 or spaces 68 of the impulse ring 14.

The inductive sensors 22 are identical. As illustrated in FIGS. 3 to 5, each inductive sensor 22 comprises a first reference coil 22a and a second sense coil 22b separated by a circumferential space 22c that is at least equal to the circumferential dimension D22a, D22b of each coil 22a, 22b. That is, the circumferential dimension and circumferential space are each measured at the same radial location on the coils 22a, 22b, in this case, at the radially outermost portion of the coils. Each inductive sensor 22 acts as an inductance comparator by generating an output based on the difference between the measured inductance of the reference coil and the sense coil.

The reference and sense coils 22a, 22b of each inductive sensor have similar shapes, an equal number of turns, and substantially identical surfaces and dimensions.

In the illustrated example, the reference and sense coils 22a, 22b of each inductive sensor have a parallelogram form. (The phrase parallelogram form includes shapes in which the radially inner and radially outer sides of the “parallelogram” are arcs of circles having a center point on an axis of rotation of the impulse ring.) The circumferential dimension of each coil 22a, 22b is defined by the longest side of the parallelogram which extends in the circumferential direction. In the illustrated example, the circumferential dimension of each coil 22a, 22b is defined by the outer side of the parallelogram.

Alternatively, the reference and sense coils 22a, 22b of each inductive sensor may have a different number of turns and/or a different shape, for example a rectangular, square or elliptical shape. Alternatively, the reference and sense coils 22a, 22b of each inductive sensor may have a circular form. In this case, the circumferential space between the reference and sense coils 22a, 22b is at least equal to the diameter of each of these coils.

As the impulse ring 14 rotates, any given tooth 66 rotates over the annular printed circuit board 38 and passes over the coils 22.

The reference and sense coils 22a, 22b of the inductive sensor 22 are arranged relative to the teeth 66 of the impulse ring 14 so that for any given tooth 66 entirely facing the circumferential space 22c (e.g., covering the entire circumferential space) between a reference and sense coils 22a, 22b with no overlap with a first one of the reference and sense coils, the tooth overlaps the other coil by an overlap ratio of 50% to 75% (See, e.g., FIG. 3).

The overlap ratio of a coil 22a, 22b is defined as the ratio of the covered portion of the coil to the total surface of the coil 22a, 22b. As such, an overlap ratio of 100%, means that a coil is entirely covered by a tooth 66. Likewise, an overlap ratio of 0% means that a coil is not covered at all by a tooth 66.

The overlap ratio of a coil has an inverse relationship to coil inductance. This means that a coil has maximum inductance when its overlap ratio is 0%, and that inductance is minimum when the overlap ratio is 100%.

As illustrated in FIG. 3, reference coil 22a of the inductive sensor 22 located on the left-hand side of the figure is at its maximum inductance with an overlap ratio of 0%, while the associated sense coil 22b is at a lower inductance as its overlap ratio is greater than 0%. In this case the output of the inductive sensor 22 is low.

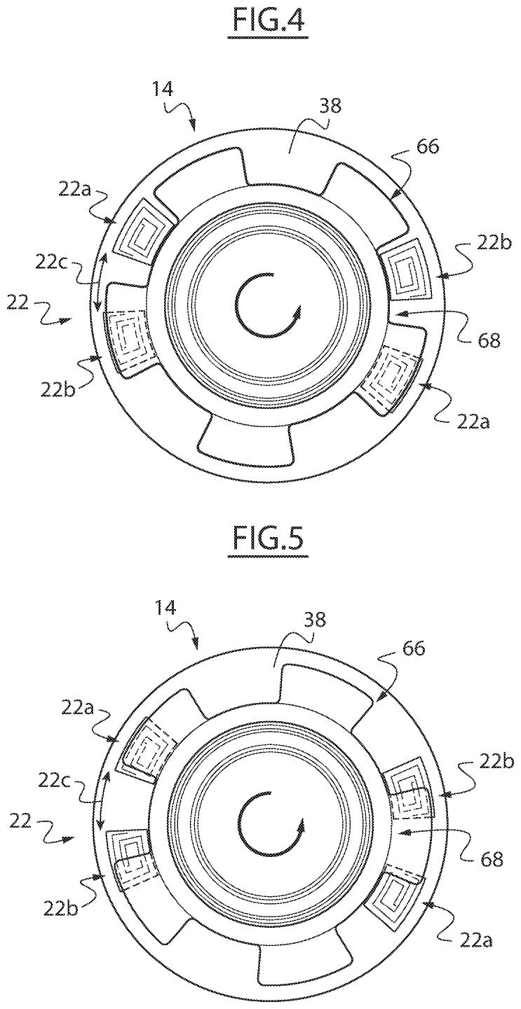

As the impulse ring 14 rotates further (FIG. 4), the overlap ratio of the coil 22b reaches 100% and the tooth 66 faces (overlies) only a fraction of the circumferential space 22c. The output of the inductive sensor 22 continues to be low because the reference coil 22a is still at its maximum inductance with an overlap ratio of 0%, while the sense coil 22b is at a lower inductance as its overlap ratio reached 100%.

As the impulse ring 14 rotates even further (FIG. 5), the overlap ratio of coil 22a increases while the overlap ratio of coil 22b decreases. The output of the inductive sensor 22 switches to high when the reference coil 22a overlap ratio becomes higher than the overlap ratio of sense coil 22b. As the rotation of the impulse ring 14 continues, the output of the inductive sensor 22 switches to low when the reference coil 22a overlap ratio becomes lower than the overlap ratio of sense coil 22b.

Therefore, the output of each inductive sensor 22 describes a series of half-duty cycles, meaning that the output is low for one half of the cycle duration and high for the other half.

In the illustrated example, the sensor device 16 comprises two inductive sensors. Alternatively, a different number of sensor elements may be employed, for example one or three or more inductive sensors preferably regularly spaced in the circumferential direction.

For a coil placed on a printed circuit board, there is a maximum number of turns that can be placed in a given dimension. If the overall inductance of the coil is still too low, adding an additional coil on another layer can increase the total inductance. It should be noted that these additional coils need to be physically aligned so that their magnetic fields positively add. When routing multiple layers, it is important to alternate the rotation of the coils in order to keep the current rotating in a constant direction.

Therefore, the inductance of a system can be increased by using a multiple layer printed circuit board that allows coil stacking as the equivalent inductance of the multi-layered coils is equal to the sum of the inductances of the individual coils. A sensor device that includes multiple coil layers 22′, 22″, 22′″ on a multi-layered circuit board is shown in FIG. 6.

Otherwise, as previously mentioned, in the illustrated example, the inner ring of the rolling bearing is the inner rotatable ring whereas the outer ring is the outer fixed ring. As an alternative, it could be possible to provide a reversed arrangement with the inner ring forming the outer rotatable ring and the outer ring forming the inner fixed ring. In this case, the impulse ring 14 is secured to the outer ring, and the sensor housing 34 of the sensor device is secured to the inner ring.

In the illustrated example, the sensor bearing unit is provided with a rolling bearing comprising one row of rolling elements. Alternatively, the rolling bearing may comprise at least two rows of rolling elements. In the illustrated examples, the rolling elements are balls. Alternatively, the rolling bearing may comprise other types of rolling elements, for example rollers. In another variant, the rolling bearing may also be provided with a sliding bearing having no rolling elements.

It should be noted that reference and sense coils can be arranged by adjusting their relative distance so as to achieve the half-duty cycle, as well as any other duty cycle with different durations for each high and low signal.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved sensor bearing units.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A sensor bearing unit comprising:
a bearing having a first ring and a second ring centered on an axis,
an impulse ring secured to the first ring of the bearing, and
a sensor device configured to detect rotational parameters of the impulse ring, the sensor device including:
a sensor housing secured to the second ring of the bearing, and
at least one inductive sensor comprising a reference coil and a sense coil supported by the sensor housing and configured to cooperate with the impulse ring,
wherein a length of a circumferential spacing between the reference coil and the sense coil is greater than or equal to a circumferential length of the reference coil and greater than or equal to a circumferential length of the sense coil.

2. The sensor bearing unit according to claim 1,
wherein the impulse ring is made of metal and includes alternating teeth and spaces, and
wherein the inductive sensor is configured to sense the teeth and spaces.

3. The sensor bearing unit according to claim 2,
wherein the reference coil and sense coil are arranged relative to the teeth of the impulse ring such that a given tooth entirely facing a circumferential space between the reference coil and the sense coil and not overlapping the reference coil, has an overlap ratio with the sense coil of 50% to 75%.

4. The sensor bearing unit according to claim 3,
wherein the reference coil and sense coil are arranged relative to the teeth of the impulse ring such that a given tooth entirely facing a circumferential space between the reference coil and the sense coil and not overlapping the sense coil, has an overlap ratio with the reference coil of 50% to 75%.

5. The sensor bearing unit according to claim 4,
wherein the sensor device further comprises a printed circuit board supporting the inductive sensor and secured to the sensor housing.

6. The sensor bearing unit according to claim 5,
wherein the printed circuit board is secured to an axial portion of the sensor housing.

7. The sensor bearing unit according to claim 5, wherein the printed circuit board is made of multiple layers.

8. The sensor bearing unit according to claim 7,
wherein the reference coil comprises a stack of reference coil layers, and
wherein an equivalent inductance of the coil is equal to a sum of the inductances of the reference coil layers.

9. The sensor bearing unit according to claim 8,
wherein sense coil comprises a stack of sense coil layers, and
wherein an equivalent inductance of the sense coil is equal to a sum of the inductances of sense coil layers.

10. The sensor bearing unit according to claim 1,
wherein the at least one inductive sensor comprise a plurality of circumferentially spaced inductive sensors.

11. The sensor bearing unit according to claim 1,
wherein the impulse ring is configured such that over a duty cycle a duration of a high signal is different than a duration of a low signal.

12. The sensor bearing unit according to claim 1,
wherein the first ring is an inner ring and the second ring is an outer ring.

13. An apparatus comprising:
a rotatable shaft, and
a sensor bearing unit according to claim 1,
wherein the first ring is fixed on the rotatable shaft.
